(19) United States
(12) Patent Application Publication
(10) Pub. No.: US 2009/0196697 A1
(43) Pub. Date: Aug. 6, 2009

(54) Multi-Function cutting machine with working depth measurement

(75) Inventors: Chia-Lung Kuo, Yunlin County (TW); Jr-Shiang You, Taipei City (TW)

Correspondence Address: BACON & THOMAS, PLLC, 625 SLATERS LANE, FOURTH FLOOR, ALEXANDRIA, VA, 22314-1176, US

(73) Assignee: CONTREL TECHNOLOGY CO., LTD., TAINAN COUNTY (TW)

(21) Appl. No.: 12/155,698

(22) Filed: Jun. 9, 2008

(30) Foreign Application Priority Data
Feb. 1, 2008 (TW) 97104051

(51) Int. Cl. B23B 49/00; B23B 51/06

(52) U.S. Cl. 408/16; 408/56

(57) ABSTRACT

A multi-function cutting machine includes a cutting tool for cutting a workpiece, a feeder for selectively feeding a gas or fluid to through a longitudinal passage of the cutting tool to the workpiece to carry away cutting chips from the workpiece, a first laser beam and a second laser beam respectively projected through the passage of the cutting tool onto the workpiece, and a detection control device for receiving the reflective light wave of the second laser beam reflected by the workpiece for measuring the working depth of the cutting tool.

### BACKGROUND OF THE INVENTION

1. Field of the Invention

The present invention relates to multi-function machines and more particularly, to a multi-function cutting machine with working depth measurement.

2. Description of the Related Art

In super-precision processing, size precision may reach 30˜50 nanometers. Using conventional processing techniques cannot reach the aforesaid precision. Therefore, many other non-conventional processing techniques, such as electrical discharge machining, abrasive machining, grinding machining, or fine laser machining, are intensively used in the industry.

For example, in cutting machining, in order to achieve high-precision small size machining, the size of the cutter must be relatively smaller, and the cutting speed must be relatively faster. There are processing machines that use laser and a cutting tool to process the workpiece at the same, accelerating the processing speed and achieving fine-processed structures.

However, because the cutting tools for processing machines using laser means are commonly small-sized tools, the working environment does not allow the worker to measure and recognize the working depth or distance easily during working of a cutting tool with a laser beam, resulting in low processing speed and complicated quality control.

### SUMMARY OF THE INVENTION

The present invention has been accomplished under the circumstances in view. It is the main object of the present invention to provide a multi-function cutting machine, which provides a working depth measurement function.

It is another object of the present invention to provide a multi-function cutting machine, which achieves high processing speed and high processing precision.

To achieve these and other objects of the present invention, the multi-function cutting machine is comprised of a cutting tool, a feeder, a first laser beam, a second laser beam and a detection control device. The cutting tool has a connection end, a working end facing a workpiece to be processed, and a passage cut through the connection end and the working end. The feeder is adapted for feeding a gas or fluid to through the passage of the cutting tool toward the workpiece to carry cut chips from the surface of the workpiece when the cutting tool is working on the workpiece. The first laser beam and the second laser beam are respectively projected through the passage of the cutting tool onto the workpiece in direction from the connection end of the cutting tool toward the working end of the cutting tool. The detection control device is adapted for receiving the reflective light wave of the second laser beam reflected by the workpiece. By means of the aforesaid arrangement, the multi-function cutting machine is practical for rapidly processing complex structures.

### BRIEF DESCRIPTION OF THE DRAWING

FIG. 1 is a schematic drawing, showing a multi-function cutting machine in accordance with a first embodiment of the present invention.

FIG. 2 is a schematic drawing, showing a multi-function cutting machine in accordance with a second embodiment of the present invention.

### DETAILED DESCRIPTION OF THE INVENTION

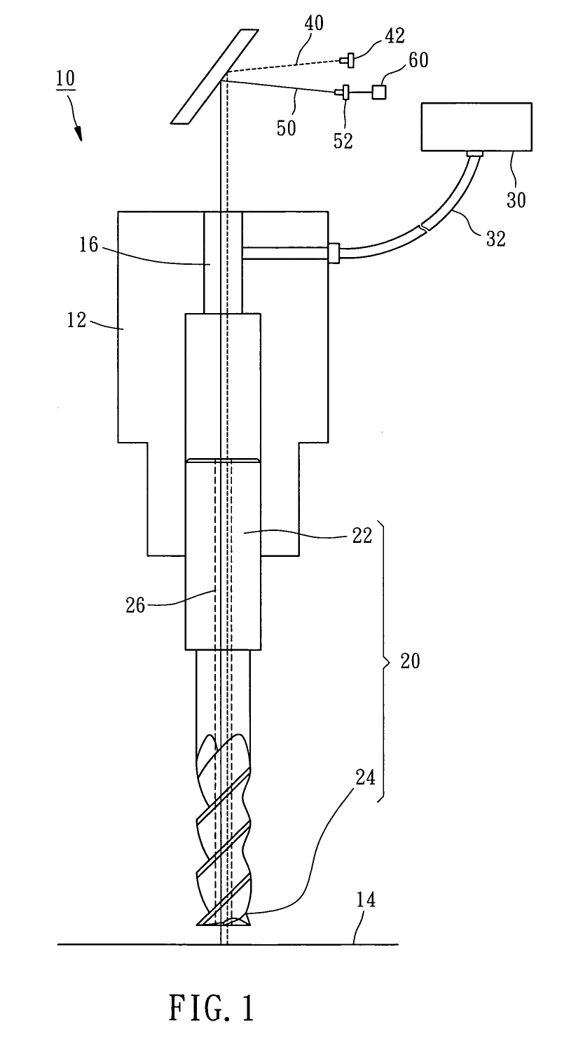

Referring to FIG. 1, a multi-function cutting machine 10 in accordance with a first embodiment of the present invention is shown comprising a cutting tool 20, a feeder 30, a first laser beam 40, a second laser beam 50 and a detection control device 60.

The cutting tool 20 is an end mill, having a connection end 22, a working end 24, and a passage 26 cut through the connection end 22 and the working end 24. The connection end 22 is connected to a main shaft 12 of the multi-function cutting machine 10. The working end 24 is kept facing a workpiece 14 to be cut. The main shaft 12 has an opening 16 in communication with the passage 26 of the cutting tool 20. The main shaft 12 can be driven to reciprocate or rotate the cutting tool 20. The multi-function cutting machine 10 further comprises a sliding table (not shown) that carries the workpiece 14 as the cutting tool 20 is cutting the workpiece 14.

The feeder 30 has a connection tubing 32 filled with a gas or fluid and connected to the main shaft 12 so that the gas or fluid can flow through the opening 16 to the passage 26 of the cutting tool 20.

The first laser beam 40 is a high-power laser beam, for example, Nd:YAG laser or carbon dioxide laser. The second laser beam 50 is a low-power laser. The first laser beam 40 and the second laser beam 50 are respectively produced by laser emitters 42 and 52 and projected into the opening 16of the main shaft 12. When projected into the opening 16 of the main shaft 12, the first laser beam 40 and the second laser beam 50 go through the passage 26 to the workpiece 14 in direction from the connection end 22 toward the working end 24. The first laser beam 40 and the second laser beam 50 can be projected onto the workpiece 14 either coaxially or non-coaxially.

The detection control device 60 is installed in the laser emitter 52 that emits the second laser beam 50, and adapted for receiving the reflective light wave of the second laser beam 50 reflected by the workpiece 14 and measuring the distance subject to the travel time of the light wave.

Referring to FIG. 1 again, when using the multi-function cutting machine 10, the main shaft 12 rotates the cutting tool 20 against the workpiece 14, causing the cutting tool 20 to cut the surface of the workpiece 14. During working of the cutting tool 20, the gas or fluid supplied from the feeder 30 goes through main shaft 12 into the inside of the passage 26 and then goes out of the passage 26 of the cutting tool 20 to the surface of the workpiece 14 via the working end 24 of the cutting tool 20, thereby carrying cut chips and dust away from the surface of the workpiece 14. Therefore, when the cutting tool 20 cuts the workpiece 14, the first laser beam 40 is working on the surface of the workpiece 14. By means of the cutting working of the cutting tool 20 and the effect of the first laser beam 40, the surface of the workpiece 14 is rapidly cut as designed.

During processing of the workpiece 14 by the cutting tool 20 and the first laser beam 40, the second laser beam 50 is also projected onto the surface of the workpiece 14, and the reflective light wave goes through the passage 26 of the cutting tool 20 to the detection control device 60 so that the detection control device 60 can determine the working depth of the workpiece 14 by means of calculating the duration from the emitting of the second laser beam 50 till reception of the corresponding reflective light wave.

As stated above, the multi-function cutting machine 10 of the aforesaid first embodiment of the present invention uses the cutting tool 20 and the first laser beam 40 to cut the workpiece and the second laser beam 50 to measure the working depth, accelerating processing speed and enhancing processing precision.

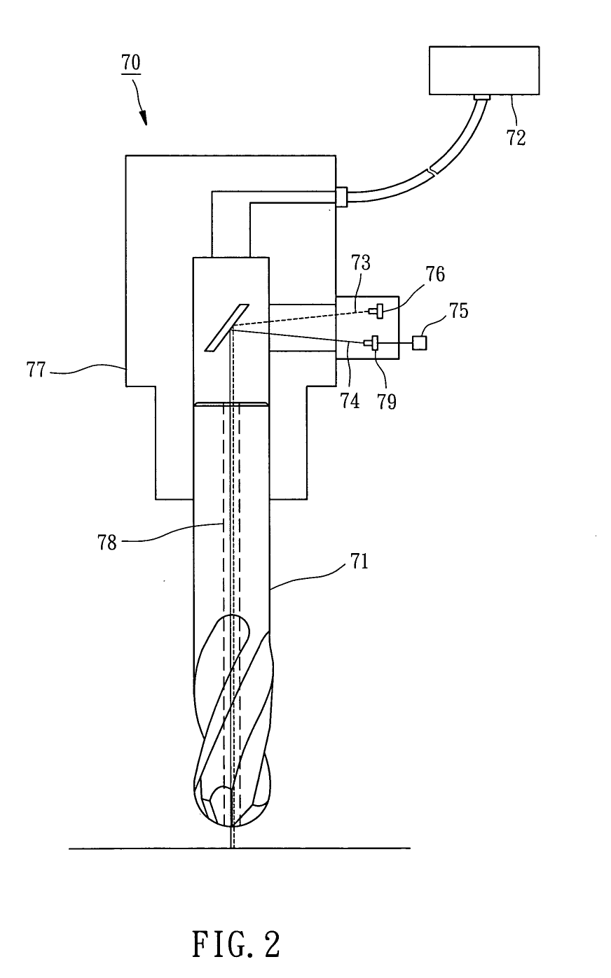

FIG. 2 illustrates a multi-function cutting machine 70 in accordance with a second embodiment of the present invention. Substantially similar to the aforesaid first embodiment, the multi-function cutting machine 70 of this second embodiment is comprised of a cutting tool 71, a feeder 72, a first laser beam 73, a second laser beam 74 and a detection control device 75. According to this second embodiment, the cutting tool 71 is a ball head mill, the laser emitters 76 and 79 that emit the first laser beam 73 and the second laser beam 74 respectively are directly installed in the main shaft 77 so that the first laser beam 73 and the second laser beam 74 are directly projected through the passage 78 of the cutting tool 71 onto the surface of the workpiece (not shown). The cutting tool 71 and the first laser beam 73 are used for cutting work, and the second laser beam 74 is employed to measure the working depth of the cutting tool 71. Therefore, this second embodiment achieves the same effects as the aforesaid first embodiment of the present invention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A multi-function cutting machine comprising:
a cutting tool, said cutting tool having a connection end, a working end facing a workpiece to be processed, and a passage cut through said connection end and said working end;
a feeder adapted for selectively feeding one of a gas and a fluid to the passage of said cutting tool;
a first laser beam and a second laser beam being respectively projected through said passage of said cutting tool onto said workpiece in direction from the connection end of said cutting tool toward the working end of said cutting tool; and
a detection control device adapted for receiving the reflective light wave of said second laser beam reflected by said workpiece.

2. The multi-function cutting machine as claimed in claim 1, wherein said first laser beam is a high-power laser beam.

3. The multi-function cutting machine as claimed in claim 1, wherein said second laser beam is a low-power laser beam.

4. The multi-function cutting machine as claimed in claim 1, wherein said first laser beam and said second laser beam are coaxially projected onto said workpiece.

5. The multi-function cutting machine as claimed in claim 1, wherein said first laser beam and said second laser beam are non-coaxially projected onto said workpiece.

6. The multi-function cutting machine as claimed in claim 1, further comprising a main shaft connected with the connection end of said cutting tool for moving said cutting tool, said main shaft having an opening disposed in communication with the passage of said cutting tool for the passing of the gas or fluid supplied by said feeder.

7. The multi-function cutting machine as claimed in claim 1, wherein said cutting tool is installed in a main shaft, a first laser emitting mounted in said main shaft and controllable to emit said first laser beam, and a second laser emitter mounted in said main shaft and controlled to emit said second laser beam.
